(19) United States
(12) Patent Application Publication
(10) Pub. No.: US 2015/0286195 A1
(43) Pub. Date: Oct. 8, 2015

(54) OPERATING UNIT

(71) Applicant: SCHNEIDER ELECTRIC INDUSTRIES SAS, Rueil-Malmaison (FR)

(72) Inventors: Yoann Szeflinski, La Buisse (FR); Emmanuel Senechault, Grenoble (FR)

(73) Assignee: Schneider Electric Industries SAS, Rueil-Malmaison (FR)

(21) Appl. No.: 14/434,833

(22) PCT Filed: Oct. 10, 2013
(86) PCT No.: PCT/EP2013/071107

§ 371 Date: Apr. 10, 2015

(30) Foreign Application Priority Data
Oct. 12, 2012 (DE) 10 2012 218 647.6

(51) Int. Cl. G05B 15/02

(52) U.S. Cl. CPC G05B 15/02

(57) ABSTRACT

An operating unit of an installation device, the device including a communication insert for controlling electrical consumers. The operating unit includes functional elements and the unit is connected by wire and/or wirelessly to the communication insert for unidirectional or bidirectional signal transmission and/or for supplying voltage. The functional elements include printed electronic components which are mechanically flexible and are situated on a mechanically flexible carrier foil.

The invention relates to an operating unit in accordance with the preamble of claim 1.

Operating units for electrical installation devices for controlling circuit elements or communication inserts are known in the most varied forms, for example for building services engineering, for industrial devices and machines or also for switch cabinets. The operating units are typically a component of the installation device, with either a single compact device unit or a module device design being implemented. It is furthermore known to arrange operating units separately from the circuit elements or communication inserts to be controlled, wherein the technical signal communication and/or the electrical supply takes place via a wired connection or via a wireless connection. Such operating units comprise different functional elements with which the most varied display functions and/or operating functions can be implemented.

The operating units are fixed with respect to their physical configuration (shape, color, design) and the arrangement of individual functional elements in the extent of the respective product spectrum. Furthermore, an integration of the operating unit into the installation device results in a binding to the installation location of the installation device. The design and the arrangement of operating units is largely non-flexible due to this system.

Printed electronic components, so-called printed electronics, are known from semiconductor engineering which are mechanically flexible and of flat construction. The manufacture of these printed electronic components takes place with the aid of normal printing processes. Functional materials are used instead of graphic printing ink as the printing material for printing electronics. As in conventional electronics manufacture, conductive, semi-conductive, dielectric and/or insulating materials as well as active materials, e.g. for printed batters, are used. A printed electronic component typically comprises a plurality of layers of functional materials which are printed over one another.

It is the object of the present invention to provide an operating unit with which customized and/or application-specific embodiments can be simply implemented.

This object is satisfied by the features set forth in claim 1. Advantageous embodiments results from the dependent claims.

The invention in accordance with claim 1 has the advantage that large freedoms are provided for the design of an operating unit with respect to its physical embodiment and to the arrangement of functional elements. Customized and application-specific solutions can easily be implemented.

Printed electronic components allow a simple and inexpensive implementation in a production-orientated aspect of different embodiments of operating units. A combination of functional elements on the basis of printed electronic components with non-printed electrical/electronic construction elements as well as with mechanical construction elements is furthermore possible in this respect.

The operating unit can be configured largely freely depending on the functions. Application-specific and/or customized demands can be composed directly by the manufacturer, architect, fitter or end user through corresponding planning means, for example electronic or computer-assisted configuration programs, with a large variability with respect to shape, color and material as well as to the positioning of functional elements.

The operating unit in accordance with the invention can be used in a room-designing manner, with independent design embodiments being able to be included in the room design as integrating embodiments, for example by representational and/or color designs. A matching to a changing room design can advantageously easily be implemented by the use of a correspondingly newly designed operating unit while maintaining existing functions. A room operation can thus be renewed and replaced simply and inexpensively as required.

The printed electronic components are mechanically flexible and of flat construction and can be manufactured with the aid of different printing processes. A number of components can be produced in a short time using inline printing processes. To reduce production costs, cost-efficient printing techniques such as screen printing, rotogravure, flexo printing and offset printing as well as digital printing processes can be used. Products manufactured in the ink jet printing process, allow different degrees of freedom with respect to design and layer thickness. Once the correct design has been found, the results can e.g. be transferred to screen printing processes; this allows larger layer thicknesses and thus very high performance of the printed material.

A printed electronic component comprises a plurality of layers of functional materials which are printed over one another. Conductive, semiconductive, dielectric and/or insulating materials as well as active materials can be used as print material for printing the printed electronic components. They can be either organic or inorganic materials. The functional materials have to be processed into print inks or print pastes to allow them to be applied by means of printing processes. In addition to the viscosity, factors such as adhesion and compatibility with the layer below play a large role in this respect to achieve an ideal function.

Due to the simple manufacturing process which is rich in variants with respect to material and color composition, customized and user-specific solutions from small production runs up to individual solutions can be produced in an excellent manner.

The operating unit in accordance with the invention is suitable for installation devices of building services engineering, with the installation device being able to be fastened to the building side and comprising a communication insert for controlling electric consumers. The operating unit can be releasably or non-releasably connected to the installation device. In another embodiment, the operating unit is arranged physically separate from the installation device at the building side. Further areas of application are industrial devices and machines or also switch cabinets.

The operating unit has a multilayer film structure in which functional elements can be integrated which are connected to the communication insert for technical signal communication and/or for electrical supply. In accordance with the invention, the functional elements can be designed as printed electronic components which are mechanically flexible.

The operating unit comprises, individually or in combination, functional elements which have electrical, optical or mechanical functions, for example as input elements and/or as output elements. Functional elements can be printed electronic components, for example in a capacitive, inductive, resistive, thermal, optical or photovoltaic design, lighting elements, e.g. OLEDs, energy stores, data stores and/or processors, as well as non-printed electronic construction elements, e.g. RFID elements, stores, batteries, LEDs, displays and/or mechanical components.

The functional elements of the operating unit typically require an electrical energy supply. In an embodiment, the electrical energy can be supplied from the installation deice or from the communication insert, with wired or wireless transfer processing being possible. Electromagnetic or inductive transfer processes are suitable for a wireless energy transfer.

In a further embodiment, an independent energy supply takes place, for example, by replaceable or self-charging energy stores. Micro fuel cells, which can be realized in a largely freely definable format, from a button cell to film structures, are advantageously suitable for this purpose. An energy store which recharges itself is an advantageous solution for applications where small construction sizes and very long running times are important. This can be achieved by a combination of a miniaturized energy store and a so-called micro energy harvesting (MEH) generator which is able to acquire electrical energy from the environment, e.g. light irradiation.

In a further embodiment, an independent energy supply takes place, for example by actuation-dependent generation of energy, e.g. by means of piezoelectric or mechanical effects. These embodiments allows a space-saving and long-life energy supply. The operating unit can be operated autonomously and thus in a mobile manner and remote from the installation location at freely selectable use locations, for example in a meeting room or in a lecture hall, by an independent energy supply.

An illumination of the operating unit or the output of light signals by the operating unit can be fed by illumination sources of the communication insert in that light is conducted through optical conductors to the corresponding lighting elements. Alternatively, autonomous illumination sources can also be used in the operating unit which gain the required electrical or optical energy from the environment of the operating unit, e.g. by electroluminescence or by photovoltaic effects.

The operating unit has a multilayer film structure into which different functional elements can be integrated. The functional elements in the form of printed electronic components are mechanically flexible and can be arranged on a flexible carrier film, preferably by a printing process, after or during their manufacture. A plurality of such carrier films with printed electronic components can be arranged within the film structure. Each carrier film hast at least one film at at least one side, advantageously at both sides, the film comprising a flexible, preferably thin substrate. Functional elements in the form of non-printed electronic construction elements and/or mechanical components can also be arranged on each film, including the carrier film. The positioning of the functional elements on the respective films is largely freely selectable within the framework of the configuration.

The film of the film structure at the building side can preferably be used for the reception of non-printed electronic components and for decoupling from electrical conductors. The user-side film can serve as a protective layer for the operating unit, including all the functional elements. Furthermore, decorative elements and operating elements or operating panels can be integrated. Intuitive operating fields are advantageous which can be realized by large-area regions as well as by tactile and/or haptic surfaces. The user-side film can advantageously be cleaned easily by using suitable materials or has dirt-repelling or self-cleaning properties. The color and area design of all films is freely selectable. The film structure made up in total of a plurality of layers can form a self-supporting structure of the operating unit and is thus mechanically flexible overall. In a further embodiment, the operating unit can be integrated in a stable frame or in a housing structure, for example in the form of a so-called panel.

The operating unit can be fastened to a carrier element at the building side, preferably to a building wall or to a piece of furniture, wherein different types of fastening are possible, for example by means of adhesive, magnetic or electrostatic adhesion or mechanical fastening techniques. The type of fastening can be matched to the properties of the carrier element, in particular to the material property and/or to the surface property. An intermediate layer is preferably formed at the rear side to be able to compensate irregularities at the carrier element, e.g. at the plaster or at wallpaper. A releasable/reversible fastening technique can advantageously also be realized to allow changing operating locations.

The functional elements of the operating unit are connected via electrical lines to a coupling point which can be connected to a coupling point at the communication insert in a wired or wireless manner for transferring signals or electrical energy. A wired connection can take place via a flexible PCB and a plug-in connection. The wireless connection in particular allows a large freedom with respect to the arrangement of the operating unit.

The communication between the communication insert and the electrical consumers can take place in a wired and/or wireless manner. The consumers can be connected directly or indirectly. On the one hand, starting from the operating element, load-switching actions can be triggered directly by the communication insert. In another embodiment, a signal transfer to load-switching actuators which then control the electrical consumers as an intermediate member can follow via the communication insert. Different communication programs serve for this, for example, bus-assisted systems such as LON, KNX or Zigbee.

The above-described design allows individual customized operating units with respect to the design aspect and with respect to the function and positioning of functional elements on a film/film structure.

Further details, features and advantages of the invention result from the following description of a preferred embodiment with reference to the drawings.

There are shown:

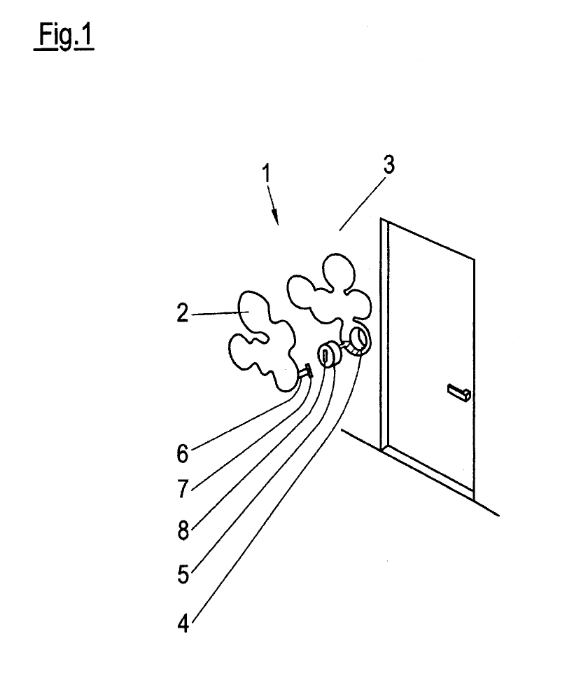

FIG. 1 a schematic representation of an arrangement of an installation device in an exploded view;

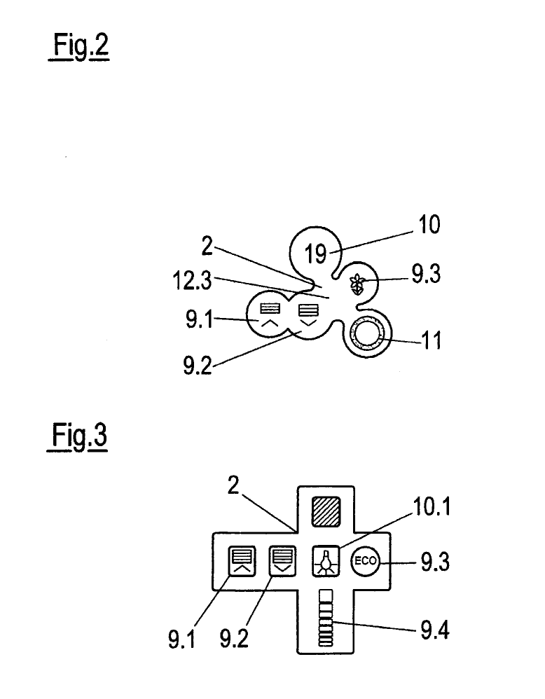

FIG. 2 a front view of the operating unit in accordance with FIG. 1,

FIG. 3 a front view of a further operating unit;

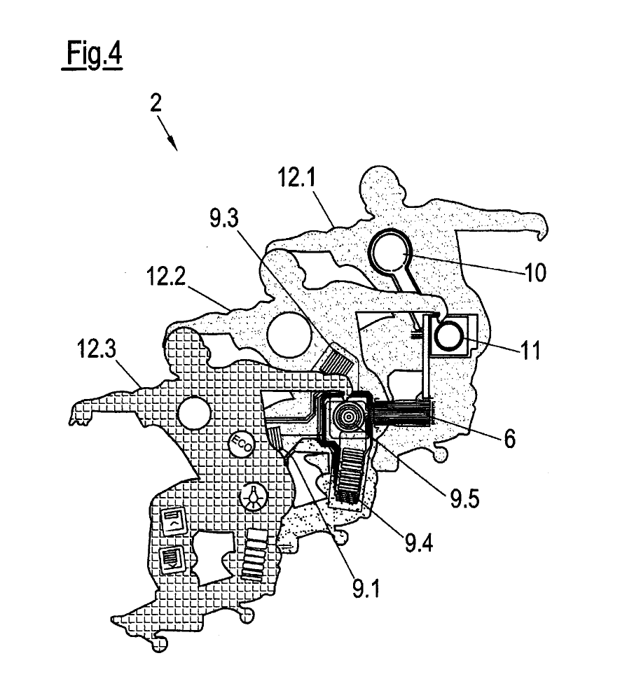

FIG. 4 an exploded view of a further operating unit;

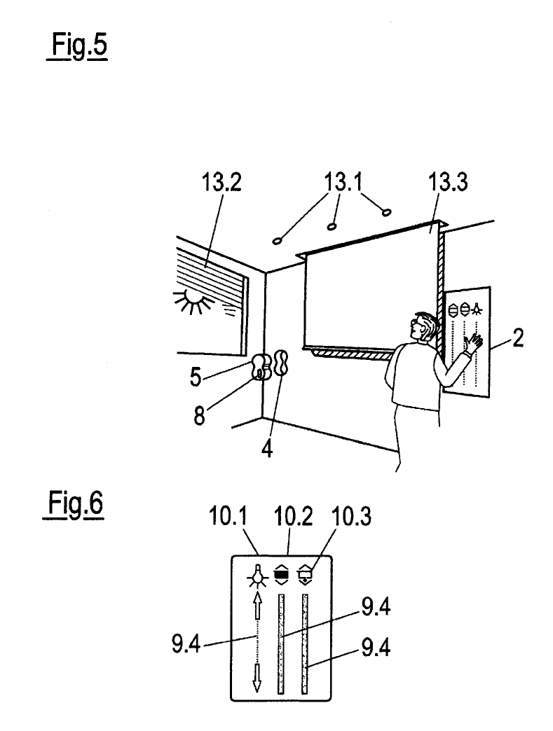

FIG. 5 a schematic representation of a further arrangement of an installation device in an exploded view; and

FIG. 6 a from view of the operating unit in accordance with FIG. 6.

Components which are the same or which have the same effect are provided with the same reference numerals in the following description.

An installation device 1 is shown schematically in FIG. 1 which is an installation device of building services engineering in the embodiment shown, having an operating unit 2 at the front side, wherein the different units are shown in an exploded view. The installation device 1 is fastened in an installation socket 4 arranged in a building wall 3. The installation device 1 has a communication insert 5 which serves for the control of electrical consumers, not shown. The operating unit 2 has different functional elements 9-11 which are connected to the communication insert 5 in a wired manner to allow an electrical supply and a technical signal supply. For this purpose, the functional elements in the operating unit 2 are connected via a flexible conductor structure 6 to a coupling point 7 in the form of a plug-in connection. A coupling point 8 in the form of a complementary plug-n connection at the communication insert 5 completes the electrical connection. In an assembled position of all units, the operating unit 2 covers the installation socket 4 and the communication insert 5 and is arranged in a surface-flush manner to the building wall 3, wherein the coupling points 7 and 8 are completely located in the installation socket 4. In accordance with an embodiment, not shown, the plug-in connection can also serve, by corresponding housing bodies, for the mechanically releasable or non-releasable connection between the operating unit 2 and the installation device 1.

The communication between the communication insert 5 and the electrical consumers is not shown in any more detail here, but can take place in a wired and/or wireless manner. The consumers can be connected directly or indirectly. On the one hand, starting from the operating element 2, electrical consumers can be directly connected by the communication insert 5. In another embodiment, a signal transfer to load-switching actuators which then control the electrical consumers as an intermediate member can follow via the communication insert 5. Different communication programs serve for this, for example, bus-assisted systems such as LON, KNX or Zigbee.

In accordance with FIG. 2, the operating unit 2 comprises different functional elements 9-11, which are each surrounded in a circular manner and which produce, combined in an areal manner, an operating surface in the form of a film 12.3. Printed electronic components 9 are designed in the form of capacitive sensors as switches or push-buttons 9-1 and 9.2 for upward and downward movements of blinds and as switches or push-buttons 9.3 for an energy-saving function. A display 10 having a temperature display as well as an annular lighting element 11 for illumination purposes is furthermore arranged. The lighting element 11 is fed via light sources, not shown, in the communication insert 5, wherein the light source and the lighting element 11 are aligned with respect to one another and are preferably fixed with respect to one another in the final assembly position to be able to transfer light. Alternatively, the lighting element 11 can also be controlled by signals transmitted electrically to the operating unit 2. The functional elements 9-11 can only be identified with reference to the visible operating fields in this representation.

A further embodiment of an operating unit 2 is shown by way of example in a front view in FIG. 3. The operating unit 2 is cruciform. Printed electronic components 9 are configured in the form of capacitive sensors as switches or push-buttons 9.1 and 9.2 for upward and downward movements of blinds, as switches or push-buttons 9.3 for an energy saving function and arranged in a sequence of a plurality of capacitive sensors as slide buttons 9-4 for a dimmable lighting. A brightness display 10.1 for the degree of dimming of the lighting is furthermore arranged as a feedback. The functional elements 9-11 can only be identified with reference to the visible operating fields in this representation.

The basic design of an operating unit 2 is shown in more detail in FIG. 4. The operating unit 2 is in this respect implemented as an areal image of a person. Printed electronic components 9 are configured in the form of capacitive sensors as switches or push-buttons 9.1 and 9.2 for upward and downward movements of blinds, as switches or push-buttons 9.3 for an energy saving function and arranged in a sequence of a plurality of capacitive sensors as slide buttons 9-4 for a dimmable lighting. An operating field lighting 9.5 is furthermore present.

The operating unit 2 comprises a film structure which is built up of a plurality of layers 12 overall and which is mechanically flexible per se. A film 12.1 at the building side has a display 10 and an annular brightness display 11 which comprises a plurality of LEDs and which reproduces the degree of dimming of the lighting. Furthermore, the film 12.1 is equipped at the rear side with an adhesive material to fasten the complete film structure to a building wall 3, for example. A middle carrier film 12.2 has the printed electronic components 9.1, 9.2, 9.3 and 9.4 which are preferably arranged on this flexible carrier film 12.2 by a printing method during their manufacture. The printed electronic components 9.1, 9.2, 9.3 and 9.4 comprise a plurality of layers of functional materials printed over one another and are designed as capacitive sensors. Connectors of the functional elements 9-11 are combined centrally on the carrier film 12.2 and are connected via a flexible conductor structure 6 to the coupling point 7 not shown here. A user-side film 12.3 serves, on the one hand, as a protective film for the operating unit 2 itself and, on the other hand, for the functional elements 9-11 arranged on the films below. Furthermore, operating fields for the functional elements 9.-11 arranged on the films lying below are located on the film 12.3.

The operating unit 2 in accordance with the invention can become a component of the decoration or can be largely (invisibly) integrated. The operating unit 2 can be manufactured in a completely customized manner, for example directly by the customer by corresponding electronic configuration programs with great variability with respect to shape, background (design, color) and to the combination of functions.

A further embodiment of the operating unit 2 is shown in FIGS. 5 and 6, with the operating unit 2 being arranged at a building wall 3 remote from the other installation device 1. Printed electronic components 9 are each designed in a sequence of a plurality of capacitive sensors as sliding buttons 9.3 for different electrical consumers (lighting 13.1, blinds 13.2, presentation area 13.3). A state display 10.1, 10.2 and 10.3 for the degree of actuation of the consumer is furthermore arranged as feedback in each case.

The functional elements 9-11 of the operating unit 2 are connected to a coupling point 7, not shown, which is connected wirelessly to a coupling point 8 at the communication insert 5 for the transfer of signals. The electrical supply takes place via energy stores, not shown, arranged in the operating unit 2. The control of the electrical consumers 13.1, 13.2 and 13.3 takes place via a bus-assisted communication system. The wireless connection allows a large freedom with respect to the arrangement of the operating unit 2. The operating unit 2 can then be operated autonomously and in a mobile manner and remote from the installation location at freely selectable use locations, for example in a meeting room or in a lecture hall.

The above description of the embodiment serves only for illustrative purposes and not for the purpose of restricting the invention. Various changes and modifications are possible within the framework of the invention without going beyond the extent of the invention or its equivalents.

### REFERENCE NUMERAL LIST

1 installation device
2 operating unit
3 building wall
4 installation socket
5 communication insert
6 conductor structure
7 coupling point
8 coupling point
9 printed electronic component
10 display, indication
11 lighting element
12 film
13 electrical consumer

1-14. (canceled)

15. An operating unit of an installation device,
wherein the installation device comprises a communication insert for controlling electrical consumers;
wherein the operating unit comprises functional elements;
wherein the operating unit is connected in a wired and/or wireless manner to the communication insert for a unidirectional or bidirectional signal transfer and/or for a voltage supply; and
wherein the functional elements comprise printed electronic components which are mechanically flexible and which are arranged on a mechanically flexible carrier film.

16. The operating unit in accordance with claim 15, wherein the building device is a building services engineering device.

17. The operating unit in accordance with claim 15, wherein the printed electronic components comprise sensors, displays, lighting elements, energy stores, data stores and/or processors.

18. The operating unit in accordance with claim 15, wherein the mechanically flexible carrier film with the functional elements comprises at least one film at at least one side.

19. The operating unit in accordance with claim 18, wherein the at least one film comprises a flexible substrate.

20. The operating unit in accordance with claim 15, wherein the operating unit comprises mechanical construction elements and/or non-printed electrical construction elements.

21. The operating unit in accordance with claim 15, wherein the functional elements at the operating unit are connected to a first coupling point that can be connected electronically in a wired or wireless manner to a second coupling part at the communication insert.

22. The operating unit in accordance with claim 15, wherein the functional elements are electrically supplied by the communication insert, independently and/or by user-side actuation.

23. The operating unit in accordance with claim 15, wherein lighting elements of the operating unit are fed by illumination sources of the communication insert and/or by independent illumination sources.

24. The operating unit in accordance with claim 15, wherein signals can be transferred in a wired and/or wireless manner between the communication insert and the electrical consumers.

25. The operating unit in accordance with claim 15, wherein the operating unit is fastened to a carrier element.

26. The operating unit in accordance with claim 15, wherein the operating unit and the installation device are not physically connected.

27. The operating unit in accordance with claim 15, wherein an arrangement and/or configuration of the functional elements and/or of the mechanically flexible carrier film can be planned using a planning means in accordance with individual and/or application-specific presettings and can be used as parameters for manufacture of the operating unit.

28. The operating unit in accordance with claim 18, wherein an arrangement and/or configuration of the functional elements and/or of the at least one film can be planned using a planning means in accordance with individual and/or application-specific presettings and can be used as parameters for manufacture of the operating unit.

29. The operating unit in accordance with claim 18, wherein an areal positioning of the functional elements between the mechanically flexible carrier film and the at least one film can be individually configured.

30. The operating unit in accordance with claim 18, wherein a shape, a material, a surface, and/or a design of the at least one film can be individually configured.

31. The operating unit in accordance with claim 15, wherein a shape, a material, a surface, and/or a design of the mechanically flexible carrier film can be individually configured.
